(19) United States
(12) Patent Application Publication
(10) Pub. No.: US 2016/0252610 A1
(43) Pub. Date: Sep. 1, 2016

(54) BLIND-SPOT RADAR SYSTEM WITH IMPROVED SEMI-TRAILER TRACKING

(71) Applicant: DELPHI TECHNOLOGIES, INC., TROY, MI (US)

(72) Inventors: MATTHEW R. SMITH, SPRINGBORO, OH (US); WALTER K. KOSIAK, KOKOMO, IN (US)

(21) Appl. No.: 14/680,115

(22) Filed: Apr. 7, 2015

Related U.S. Application Data
(60) Provisional application No. 62/120,937, filed on Feb. 26, 2015.

(51) Int. Cl. G01S 13/93; G01S 7/41; G01S 13/04

(52) U.S. Cl. CPC G01S 13/931; G01S 13/04; G01S 7/411; G01S 2013/9332

(57) ABSTRACT

A radar system for detecting an object in a blind-spot zone of an operator of a vehicle includes the step of providing a system configured to detect objects proximate to a vehicle using radar. The system detects objects within a first portion of the blind-spot zone, and is reconfigured to detect objects within a second portion of the blind-spot zone different from the first portion. Once an alert for the operator is activated indicating that an object is present in the blind-spot zone, the activation of the alert is maintained a time-interval after the object has exited the blind-spot zone. The time-interval that the alert is maintained is varied in accordance with a classification or size of the object. When the object is classified as a semi-trailer, the time-interval is longer than when the object is classified as something else, an automobile or motorcycle for example.

### CROSS-REFERENCE TO RELATED APPLICATION

This application claims the benefit under 35 U.S.C. §119(e) of U.S. Provisional Patent Application No. 62/120,937, filed Feb. 26, 2015, the entire disclosure of which is hereby incorporated herein by reference.

### TECHNICAL FIELD OF INVENTION

This disclosure generally relates to radar system for detecting objects proximate to a vehicle and in a blind-spot of an operator of the vehicle, and more particularly relates to an improved way to prevent intermittent or inconsistent tracking of radar signals reflected by a semi-trailer or a tractor-trailer type vehicle.

### BACKGROUND OF INVENTION

It is known that the middle area of semi-trailers (between the hitch area of a tractor and wheels of the trailer) often have little structure below the trailer storage area, so there is a large area from the road to the storage area where there is little or nothing to reflect a radar signal emitted by a radar system. This causes problems with the radar-based blind-spot object detection systems that detect the presence of an object in the adjacent lane to a vehicle on which the blind-spot detection system is mounted. For example, the blind-spot system may erroneously report that the adjacent lane is not occupied when in fact a semi-trailer is present. The situation when such a system inadvertently stops detecting a semi-trailer that is actually present is sometimes referred to a blind-spot alert 18 discontinuity. When the middle section of the semi-trailer is not detected, it has been observed that known systems sporadically detect the rear set of wheels of the trailer behind the typically sensed portion of the blind-spot region and the far side of the semi-trailer beyond the far side the typically sensed portion of the blind-spot region. It is also common for the far-side radar reflections to have bounced off the road and therefore indicating a distance further than the actual distance from the sensor to the far-side of the trailer.

### SUMMARY OF THE INVENTION

Described herein are a radar system and a method of operating the radar system that provide improved radar tracking of semi-trailers present in the blind-spot of an operator adjacent a vehicle being operated by the operator.

In accordance with one embodiment, a system for detecting an object in a blind-spot zone of an operator of a vehicle is provided. The system includes a radar sensor and a controller. The radar sensor emits a radar signal toward a blind-spot zone, detects a radar track reflected by an object in the blind-spot zone, and outputs a detection signal indicative of a detected object in the blind-spot zone. The controller receives a detection signal from the radar sensor, and determines if the detection signal is indicative of a detected object in the blind-spot zone. The controller activates an alert to indicate to the operator that the detected object is present in the blind-spot zone. The controller deactivates the alert a first time-interval after the detected object exits the blind-spot zone when the detected object is not larger than the size threshold, and deactivates the alert a second time-interval after the detected object exits the blind-spot zone when the detected object is larger than the size threshold, wherein the second time-interval is greater than the first time-interval.

In another embodiment, a system for detecting an object in a blind-spot zone of an operator of a vehicle is provided. The system includes a radar sensor and a controller. The radar sensor emits a radar signal toward a blind-spot zone, detects a radar track reflected by an object in the blind-spot zone, and outputs a detection signal indicative of a detected object in the blind-spot zone. The controller receives the detection signal and determines if the detected object is within a first portion of the blind-spot zone. The controller determines if the detected object is greater than a size threshold, and reconfigures the system to detect objects within a second portion of the blind-spot zone different from the first portion if the detected object is within a first portion of the blind-spot zone and the detected object is greater than a size threshold.

In another embodiment, a method of operating a radar system for detecting an object in a blind-spot zone of an operator of a vehicle is provided. The method includes the step of providing a system configured to detect radar tracks indicative of a detected object proximate to a vehicle using radar. The method also includes the steps of detecting, by the system, a radar track within the blind-spot zone, and activating an alert to indicate to the operator that the detected object is present in the blind-spot zone. The method also includes the steps of deactivating the alert a first time-interval after the detected object exits the blind-spot zone when the detected object is not larger than the size threshold, and deactivating the alert a second time-interval after the detected object exits the blind-spot zone when the detected object is larger than the size threshold, wherein the second time-interval is greater than the first time-interval.

In another embodiment, a method of operating a radar system for detecting an object in a blind-spot zone of an operator of a vehicle is provided. The method also includes the steps of providing a system configured to detect radar tracks indicative of a detected object proximate to a vehicle using radar, and detecting, by the system, a radar track within a first portion of the blind-spot zone. The method also includes the steps of determining that the detected object is larger than a size threshold, and reconfiguring the system to detect radar tracks within a second portion of the blind-spot zone different from the first portion when the detected object is larger than the size threshold.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a so-called blind-spot areas adjacent a vehicle that are observed by a radar system in the vehicle in accordance with one embodiment;

FIG. 2A is method of operating a radar system for detecting an object in a blind-spot in accordance with one embodiment;

FIG. 2B is method of operating a radar system for detecting an object in a blind-spot in accordance with one embodiment; and

FIGS. 3A, 3B, and 3C in combination illustrate another method of operating a radar system for detecting an object in a blind-spot in accordance with one embodiment.

### DETAILED DESCRIPTION

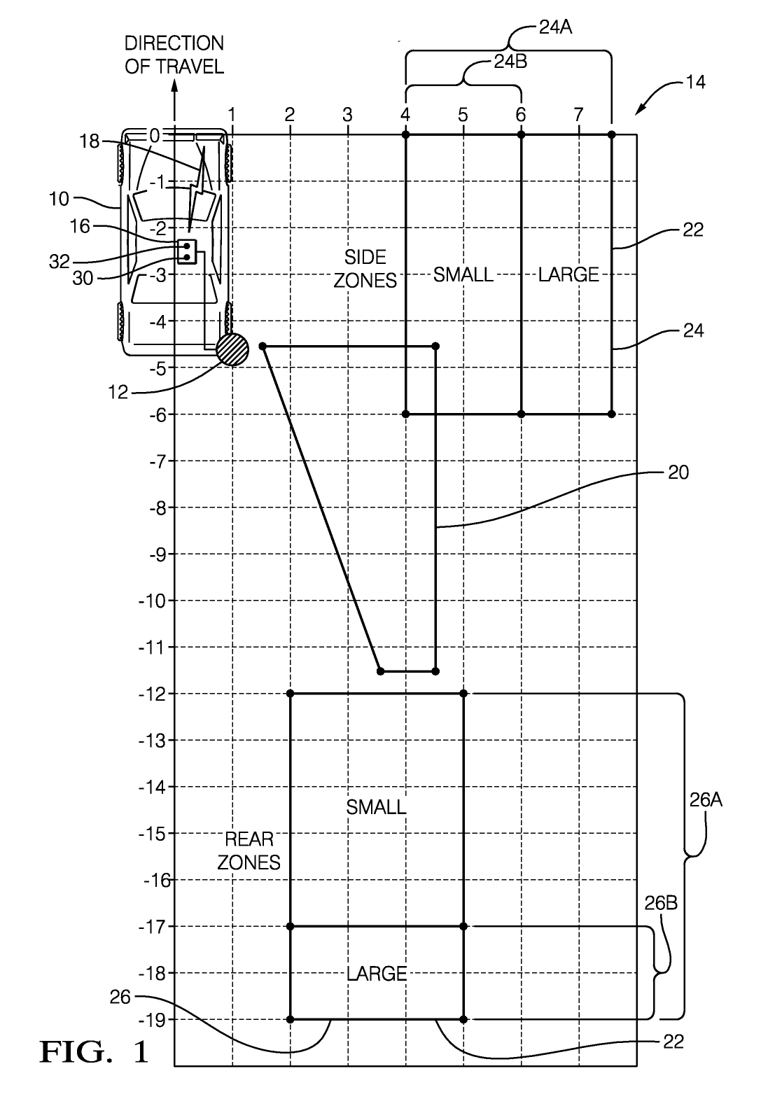

FIG. 1 illustrates a non-limiting example of a vehicle 10 (i.e. a host vehicle) equipped with a radar based object detection system, hereafter the system 12. The system 12 is illustrated as being installed on the right-rear corner of the vehicle 10, but those in the art will recognize that comparable systems may in addition be installed on the left-rear corner of the vehicle 10, or at other locations on the vehicle 10. The system 12 is illustrated as only being installed at one location on the vehicle only for the purpose of simplifying the explanation of the system 12. In general, the system 12 is configured to detect an object in a blind-spot zone 14 of an operator (not shown) of the vehicle 10. As used herein, the blind-spot zone 14 is any location about the vehicle that is not readily observable by the operator using only peripheral vision. As such, areas observable by rear-view and/or side-view minors are included in the blind-spot zone 14. By way of further example and not limitation, if any portion of an object is in the blind-spot zone 14, that presence can cause a blind spot alert. There may also be hysteresis around this area such that the area observed may expand once the blind spot alert is active. Also, a tracked target present in areas to the rear and side of the vehicle may not trigger unless the center of the object is located within the blind-spot zone 14.

It has been observed that some radar based object detection systems configured to detect objects in the blind-spot zone 14 and in an adjacent lane beside the vehicle do not consistently detect the presence of a semi-trailer traveling beside the vehicle in an adjacent lane. In particular, some systems fail to detect a semi-trailer proximate to the vehicle 10 because the area underneath the semi-trailer does not substantively reflect radar signals. That is, some systems are focused downward enough that empty space or void area below the semi-trailer, forward of the trailer's wheels, and behind the tractor registers as being empty or vacant. This problem can be solved by using a method that temporarily revises (increases) the areas proximate to the vehicle where the system 10 will track a target or object, and/or revises the duration of timers used to hold the blind-spot alert 18 in an active state when certain conditions are met.

A detected object may be classified as a semi-trailer when, for example, the length of the detected object indicated by a radar track is determined to be greater than a threshold, 7.5 meters (m) for example. Once an object is classified as a semi-trailer, the object remains classified as a semi-trailer for the entire duration of the blind-spot alert 18. Alternative requirements for classification as a semi-trailer may include a maximum relative velocity of the other vehicle in relation to the host vehicle (e.g., less than 2 m/s) and that the host vehicle be traveling faster than a minimum speed (e.g., greater than 5 m/s).

The system 12 may include or be electrically coupled to a controller 16. The controller 16 may include a processor (not shown) such as a microprocessor or other control circuitry such as analog and/or digital control circuitry including an application specific integrated circuit (ASIC) for processing data as should be evident to those in the art. The controller 16 may include memory, including non-volatile memory, such as electrically erasable programmable read-only memory (EEPROM) for storing one or more routines, thresholds (e.g. a first time-interval 30 and a second time-interval 32), and captured data. The one or more routines may be executed by the processor to perform steps for determining if signals received by the controller 16 indicate that an object is present in an area proximate to the vehicle 10 as described herein.

When the system 12 is initially powered, the controller 16 is preferably configured to detect objects within a first portion 20 of the blind-spot zone 14. The size, shape, and positioning of the first portion 20 relative to the vehicle 10 is selected so that an alert 18 for the operator is activated if there is anything that the vehicle could collide with if the vehicle 10 were to change lanes. The activation of the alert 18 may be communicated to the operator by way of, but not limited to, illuminating a light, and/or sounding a chime, as will be recognized by those in the art. Relatively small objects such as an automobile or motor cycle will continue to be detected or tracked by the system 12 so the alert 18 will continue to be activated for a first time-interval 30 after the detected object leaves the first portion 20, a half-second for example.

However, if a detected object is determined to be greater than a size threshold, longer than 7.5 m for example, the object is classified as a semi-trailer, and the system 12 is advantageously reconfigured to detect objects within a second portion 22 of the blind-spot zone 14 different from the first portion 20. By way of example and not limitation, the second portion 22 may include a side portion 24 directly beside the vehicle 10 that is further away sideways from the vehicle 10 than all or part of the first portion 20, and a rear portion 26 that is further behind the vehicle 10 than all or part of the first portion 20. It should be understood that an object may cause more than a single distinct reflection of a radar signal emitted by the system 12, so an object may be indicated by multiple, but close together radar targets or tracks. After an object is classified as a semi-trailer, the system 12 may continue to track multiple radar tracks within both the first portion 20 or the second portion 22, or both portions, and keep the alert 18 activated for a second time-interval 32 after the first portion 20 and/or the second portion 22 are clear of radar tracks, one second for example. Once the various portions are clear of radar tracks, the system 12 may again be reconfigured to an initial state where only the first portion is observed or monitored by the system 12 for objects.

To more consistently detect and track a semi-trailer, but avoid keeping the alert 18 activated for an unnecessarily long time, the side portion 24 and the rear portion 26 may be further divided or split into large zones, e.g. large-side zone 24A and large rear zone 26A, and small zones, e.g. small-side zone 24B and small-rear zone 26B that are encompassed by the large-side zone 24A and large-rear zone 26A, respectively. Then when radar tracks are detected in these various zones, different timer values can be used to determine if one or more of the radar tracks are associated with or indicative of an object such as a semi-trailer. Because radar these tracks often come and go (i.e. appear and disappear) rather than be detected in a continuous uninterrupted manner for the entire duration that the obstacle is present, when a radar track appears and then leaves, a record of its presence is advantageously held or persisted for some appropriate time-interval. As such, the controller 16 may be configured to, for example, operate timers to indicate how much time has passed since a particular radar track disappeared in each of four split zones, and maintain the activation of the alert 18 if the particular radar track re-appears in the zone within less than a predetermined interval of time. That is, if a radar track disappears, the alert 18 is temporarily maintained for a time-interval that may be varied depending on where in the blind-spot zone 14 the radar track is located, and/or the classification of the object or target indicated by the radar track. If the radar track remains disappeared for more than the selected time-interval, i.e. the radar track does not reappear is less than the selected time-interval, then the alert 18 is cancelled or turned off. By way of example and not limitation, the following timers may be suitable location timer thresholds for determining that a radar track that has ‘disappeared’ from a particular zone is actually gone, so the alert 18 should be deactivated: small-rear or small-side <1.5 s; small-rear <4.5 s and large-side <3 s; small-side <4.5 s and large-rear <3 s; small-rear <12 s and large-side <1 s; and/or Small-side <12 s and large-rear <1 s.

By way of further explanation, once the target has been classified as a semi-trailer, i.e. the semi-trailer classification has been established, the algorithm may continue the alert 18 for an extended time-interval, even when the radar track briefly ‘disappears’. It does this by increasing the time-interval that the alert 18 is held once the conditions causing the alert 18 have dissipated (e.g., from the half second value of the first time-interval 30 to the one second value of the second time-interval 32) and by looking for new radar tracks appearing in different locations. The algorithm looks for cycles where any radar track falls into zones to the outside lateral edge of the blind-spot zone and behind the longitudinal edge of the blind-spot zone. Example sized for the various zones may be, for example:
Longitudinally from 12 to 19 m behind the front of the host vehicle and 2 to 5 m laterally from the lateral center of the host vehicle (i.e. the large-rear zone 26A).
Longitudinally from 12 to 17 m behind the front of the host vehicle and 2 to 5 m laterally from the lateral center of the host vehicle (i.e. the small-rear zone 26B).
Longitudinally from 0 to 6 m behind the front of the host vehicle and 4 to 7.5 m laterally from the lateral center of the host vehicle (i.e. the large-side zone 24A).
Longitudinally from 0 to 6 m behind the front of the host vehicle and 4 to 6 m laterally from the lateral center of the host vehicle (i.e. the small-side zone 24B).

Several timers may be used to measure the amount of time since a valid radar track of low relative velocity (e.g., less than 2 m/s) has fallen into these different zones.

In the absence of a radar track in the actual blind-spot zone, the algorithm serves to continue or maintain the alert 18 when the semi-trailer classification has been established, and the timers meet at least one of a certain number of maximum timer requirements, such as:
Time since a radar track was in (i.e. has disappear from) the small-rear zone 26B or the small-side zone 24B is less than 1.5 s;
Time since a radar track was in the small-rear zone 26B is less than 4.5 s and the time since a radar track was in the large-side zone 24A is less than 3 s;
Time since a radar track was in the small-side zone 24B is less than 4.5 s and the time since a radar track was in the large-rear zone 26A is less than 3 s;
Time since a radar track was in the small-rear zone 26B is less than 12 s and the time since a radar track was in a large-side zone 24A is less than 1 s; or
Time since a radar track was in the small-side zone 24B is less than 12 s and the time since a radar track was in the large-rear zone 26A is less than 1 s.

The controller 16 may be further configured to employ target pattern matching based on the detection history as the semi-trailer passes through the field of view of the system.

The controller 16 may be further configured to turn off the alert 18 after it is determined that the semi-trailer has moved entirely forward of the blind-spot zone 14, which occurs when the semi-trailer is traveling faster than the vehicle 10. This reduces the unnecessarily long holds for this particular situation. For example, if the following are all true, the likely-drop classification is set to FALSE (making alert holds impossible):
Relative velocity (not absolute value) of the radar track in the blind-spot zone>1.0 m/s, i.e. the object is moving faster than the vehicle 10 and is likely to exit the front side of the blind-spot zone 14;
Longitudinal (i.e. forward/behind) position of the radar track in the blind spot zone is >−2 m, i.e. less than 2 m behind of the front bumper of the vehicle 10; or
Large-rear zone timer >1.5 s.

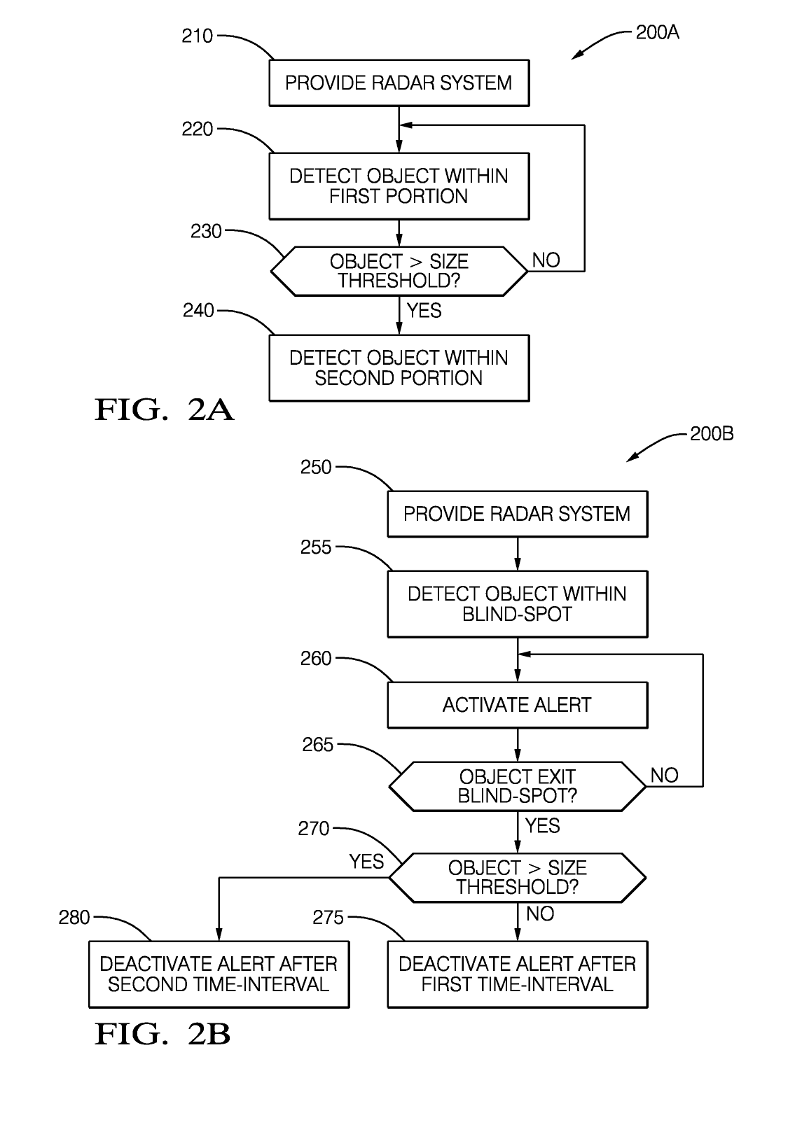

FIG. 2A illustrates a non-limiting example of a method 200A of operating a radar system (the system 12) for detecting an object in a blind-spot zone 14 of an operator of a vehicle 10.

Step 210, PROVIDE RADAR SYSTEM, may include providing, i.e. installing the system 12 on the vehicle 10. In general, the system 12 is configured to detect objects proximate to the vehicle 10 using radar. Multiple radar sensors may be installed at different locations on the vehicle 10 so objects can be detected in any direction about the vehicle 10. It is contemplated that the left rear corner of the vehicle 10 could be similarly equipped to detect objects to the left of the vehicle 10 just as it shown in FIG. 1 for detecting objects to the right of the vehicle 10

Step 220, DETECT OBJECTS WITHIN FIRST PORTION, may include configuring the system 12 to only detect objects within the first portion 20 of the blind-spot zone 14. By limiting the area of detection to the first portion 20, the system 12 is not unnecessarily activating alert 18s when objects are detected that are unlikely to collide with the vehicle 10 if the operator of the vehicle 10 changes lanes.

Step 230, OBJECT>SIZE THRESHOLD?, may include determining that a detected object is greater than a size threshold, longer than 7.5 meters for example. In order to determine the size of the object, the system 12 may be momentarily or temporarily reconfigured to detect objects outside of the first portion 20, for example in the side portion 24 and/or the rear portion 26. Alternatively, the size of the object may be indicated by the strength of a reflected radar signal, the number if radar tracks, or radar targets in close proximity to each other, or a recognizable pattern of radar tracks that are indicative of the object being a semi-trailer.

Step 240, DETECT OBJECTS WITHIN SECOND PORTION, may include reconfiguring the system 12 to detect objects within a second portion 22 of the blind-spot zone different from the first portion 20. The system 12 may continue to observe the first portion 20 in addition to the second portion 22. The system 12 may continue to observe both the first portion 20 and the second portion 22 until no radar targets or radar tracks are detected in either portion for a time-interval or until one or more of the various timers described elsewhere herein expire. By tracking radar targets or radar tracks in the second portion 22, the system 12 will not inadvertently fail to detect a semi-trailer proximate to the vehicle 10 because the area underneath the semi-trailer that does not substantively reflect radar signals occupies the first portion 20. Once the system 12 determines that the semi-trailer is clear of the vehicle 10 and no longer presents a collision potential, the system may revert to monitoring or observing only the first portion 20 of the blind-spot zone 14.

FIG. 2B illustrates a non-limiting example of a method 200B of operating a radar system (the system 12; FIG. 1) for detecting an object in a blind-spot zone 14 of an operator of a vehicle 10.

Step 250, PROVIDE RADAR SYSTEM, may include providing a system 12 configured to detect radar tracks indicative of a detected object proximate to the vehicle 10 using radar by installing a suitable radar sensor and a controller 16 on the vehicle.

Step 255, DETECT OBJECT WITHIN BLIND-SPOT, may include detecting, by the system 12, a radar track within the blind-spot zone 14. By way of example, radar sensor may output a detection signal that is provided to the controller 16. The controller 16 may be configured to process the detection signal in order to discern that an object such as another vehicle is present in the blind spot zone. The controller 16 may be further configured to capture a series of samples of the detection signal, and tabulate a list of targets (Target[i]) indicated by the detection signal, and groups the targets in order to classify the nature of the detected object, where the classification may include a semi-trailer, an automobile, a motorcycle, and the like.

Step 260, ACTIVATE ALERT, may include activating an alert to indicate to the operator that the detected object is present in the blind-spot zone. The alert may be an illuminated indicator, a chime, a vibration of the steering wheel, or any combination thereof. The alert may be maintained in an activated state for as long as the object is present in the blind-spot zone 14, and for a selected time-interval after the object exits the blind-spot zone 14.

Step 265, OBJECT EXIT BLIND-SPOT?, may include the controller 16 operating various timers to keep track of how long various portions of the blind-spot zone 14 are free from radar returns, i.e. no target are detected, before indicating that the object has exited the blind-spot zone 14.

Step 270, OBJECT>SIZE THRESHOLD?, may include the controller 16 framing a map or otherwise tabulating the locations of the targets that are moving together, and estimating the size of the object based on the locations of the targets associated with the object. The size is then compared to a threshold in order to classify the object as, for example, a semi-trailer if the length of the object is greater than a size threshold, 7.5 m for example.

Step 275, DEACTIVATE ALERT AFTER FIRST TIME-INTERVAL, may include deactivating the alert a first time-interval 30; a half second for example, after the detected object exits the blind-spot zone 14 when the detected object is not larger than the size threshold.

Step 280, DEACTIVATE ALERT AFTER SECOND TIME-INTERVAL, may include deactivating the alert a second time-interval 32, one second for example, after the detected object exits the blind-spot zone when the detected object is larger than the size threshold. As suggested by the example values for the time-intervals, the second time-interval 32 is greater than the first time-interval 30.

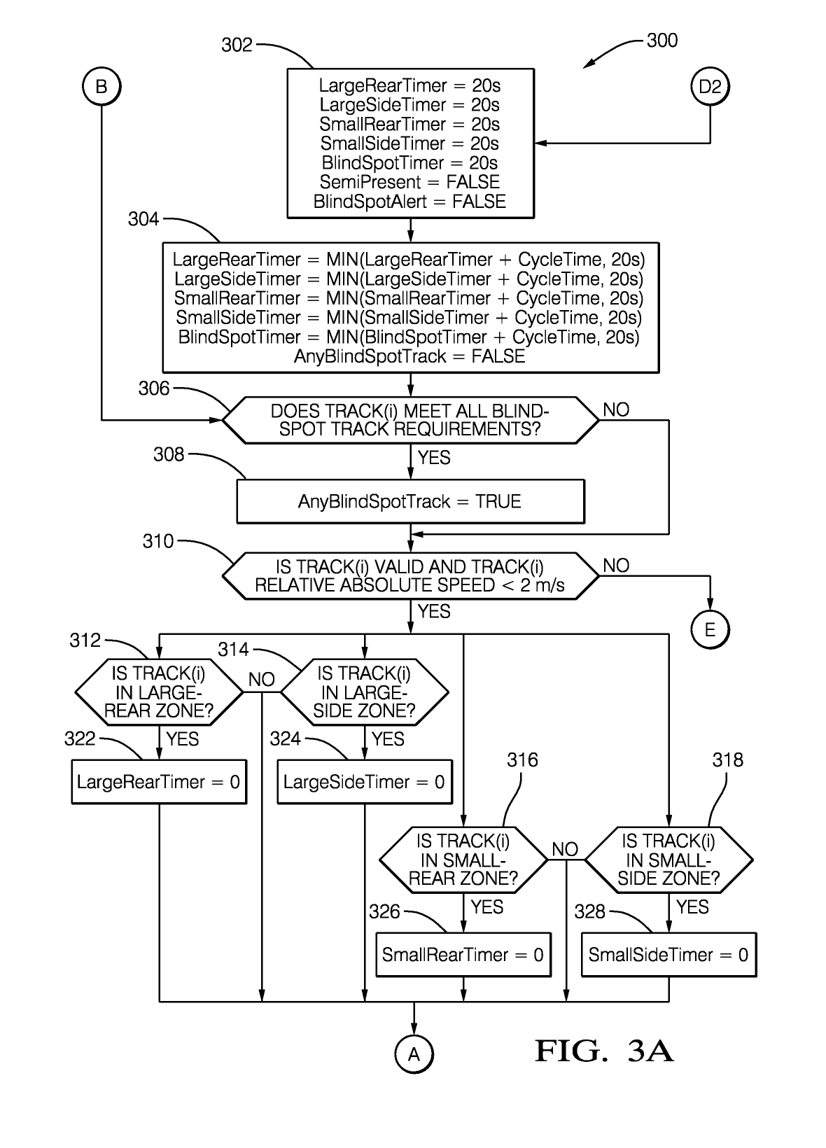

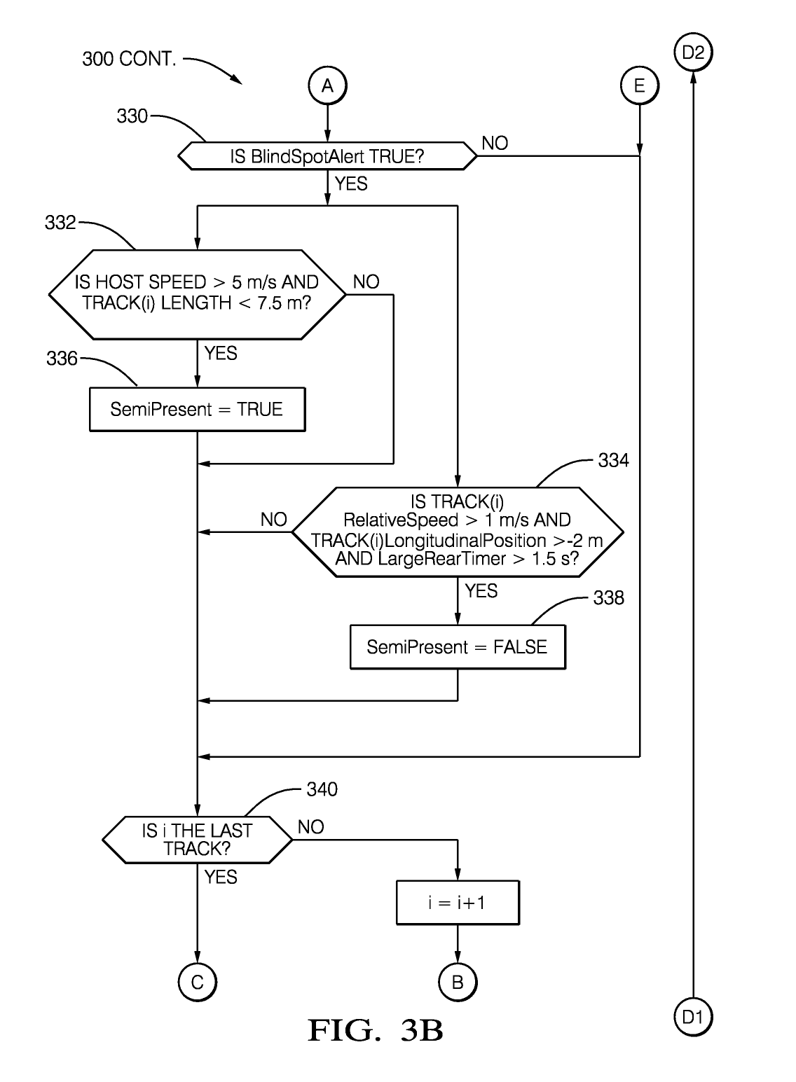

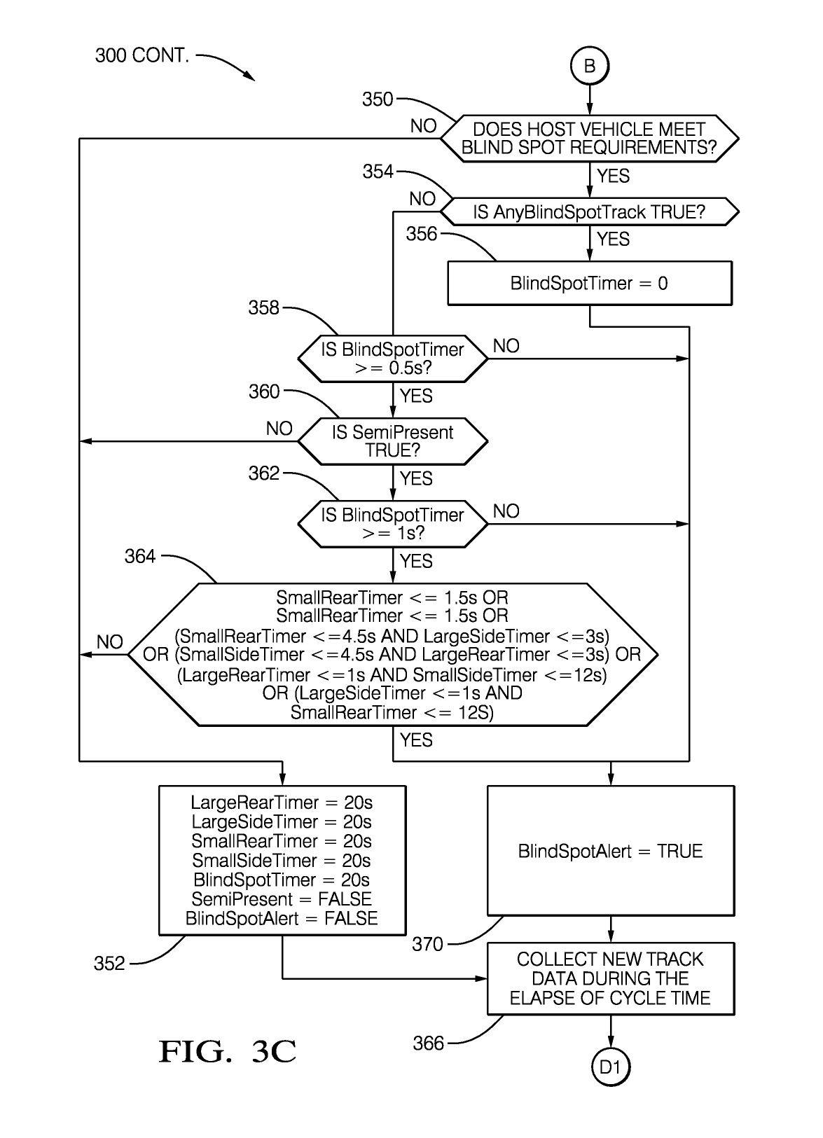

FIG. 3 FIGS. 3A, 3B, and 3C in combination illustrate another non-limiting example of a method 300 of operating a radar system (the system 12) for detecting an object in a blind-spot zone 14 of an operator of a vehicle 10. An improvement to the system 12 provide by the method 300 over prior examples of radar detection systems is that the activation of an alert 18 to a vehicle operator is maintained for a selected time-interval after a radar track of a radar reflection disappears or stops being detected by the system 12, and the time-interval that the alert 18 is maintained is dependent on, among other things, where in the blind-spot zone 14 the radar track was located prior to disappearing. Furthermore, prior systems may cause the alert 18 to persist unnecessarily long after the radar track is present. The method 300 describe herein also improves this problem by detecting when the semi-trailer has exited the blind-spot zone 14, i.e. has fully passed the vehicle 10.

Step 302 initialized the system 12 in preparation for detecting objects in the first portion 20 of the blind-spot zone 14. The initialization of the various timers is done so random values that may appear within memory accessed by the controller 16 are not used. Initialization may be performed when the vehicle 10 is started, and/or in cases when blind-spot zone 14 was vacant or no alerts have been issued for some time. A value corresponding to twenty seconds (20 s) is used as none of the suggested thresholds presented herein is greater than twenty seconds. While not specifically shown in the method 300, the area in which a radar reflection will be tracked is initially limited to the first portion 20 of the blind-spot zone 14, and radar reflections outside of the first portion may be ignored.

Step 304 increments the various timer values by a CycleTime value comparable to, for example, 0.05 seconds. That is, the tracking of each target detected and the detection of any new targets is repeated or updated every CycleTime, e.g. 0.05 seconds.

Step 306 corresponds to various steps known in the blind spot detection arts to initially detect an object based on the detection of one or more radar tracks, and determine if a particular radar track is actually indicative of an object, or if a radar track is noise. By way of example and not limitation, a detected radar track may be deemed an actual object or a detected object if the radar track is moving relative to the ground and/or persists for more than a predetermine period of time. If multiple radar reflections are detected at different locations about the vehicle, each of those reflections is assigned to a previously known radar track number (e.g. Track[i]) if it is determined to correspond to that previously known track number, or is assigned to a new track number if certain criteria are met. Alternatively, tracks may actually represent groups of tracks that are deemed to be part of the same object

If a particular radar track (Track[i]) meets the criteria necessary to be indicative of an object in the blind-spot zone, the method 300 proceeds to step 308 where the AnyBlindSpotTrack flag is set to TRUE. If Track[i] does not meet the criteria necessary to be indicative of an object in the blind-spot zone, the method 300 bypassed the Step 308 and proceeds to step 310.

Step 310 determines if a particular track is valid, e.g. has persisted for more than 0.5 seconds (i.e. more than 10 samples if the CycleTime=0.05 s), and that the particular track is moving relative to the vehicle 10 at an absolute rate of less than some threshold, 2 m/s for example. Determining relative velocity is advantageous as doing so limits the undesirable effect of erroneously holding onto tracks for too long. If an object that causes certain radar tracks are moving quickly, then the driver will see that they have long since departed, so there is no reason to activate the alert 18. Determining relative velocity helps to solve the problem of when the normal persistence of a tracked target is insufficient to maintain the alert 18, especially when two vehicles (the vehicle 10 and the detected or tracked vehicle) are moving at roughly the same speed so the tracked vehicle lingers in the blind-spot zone 14.

If the outcome of Step 310 is YES, the particular radar track Track[i] is passing or being passed by another vehicle traveling in the same direction, then the expected value of the speed difference between the vehicle 10 and the Track[i] is relatively slow, between +2 m/s and −2 m/s for example. That condition is taken as an indication that the Track[i] corresponds to another vehicle lingering in the blind-spot zone 14 of the vehicle 10, so is more likely to cause the problem of a discontinuous alert if the object is a semi-trailer. Lingering objects are also less likely to appear to be held too long if the alert is held beyond the object moving out of the blind-spot zone. If YES, the method 300 proceeds to the tests indicated by Steps 312, 314, 316, 318. If NO, because the absolute value of the relative speed difference is greater than 2 m/s, then that indicates that the object will move quickly through the blind-spot and will be less likely to cause a discontinuous activation of the alert 18. If NO, the method 300 proceeds to Step 340 on FIG. 3B via connection E.

Steps 312, 314, 316, 318 are performed to detect additional tracks outside of the first portion 20, for example in the second portion 22 which includes the side portion 24 and the rear portion 26 which may be further defined as the large-side zone 24A and the large-rear zone 26A, respectively, which encompass the small-side zone 24B and the small-rear zone 26B, respectively. If radar tracks are detected in the second portion 22, that may be an indication that a semi-trailer is in the adjacent lane. If radar tracks are detected in any of the zones that make up the second portion 22 (e.g. the large-side zone 24A, the large-rear zone 26A, the small-side zone 24B, and the small-rear zone 26B), then the corresponding timers are cleared or zeroed as illustrated by steps 322, 324, 326, and 328. It should be understood that all of these tests are performed in parallel, so when the method 300 proceeds to Step 330 on FIG. 3B via connection A, only the timers associated with zones where tracks were detected will be zeroed. The two rear zones are designed to correspond with circumstances where the middle section of the semi-trailer is not detected but the rear set of wheels fall into this region. The two side zones are designed to correspond with cases wherein the radar is reflected off the far side of the semi-trailer.

Step 330, “Is BlindSpotAlert TRUE?” refers to the assessment made in the previous iteration (i.e.—one CycleTime ago). If the outcome of the Step 330 is NO, the method 300 proceeds to Step 340 where, if all of the radar tracks have been processed, the method 300 proceeds to Step 350 on FIG. 3C via connection C, where further tests may result in setting the value of BlindSpotAlert to TRUE. If the outcome of the Step 330 is YES, the method 300 proceeds to parallel Steps 332 and 334 where the various detected radar tracks (Track[i]) are examined to determine if a semi-trailer is present (Step 336: SemiPresent=TRUE), or if a previously detected semi-trailer has passed forward of the vehicle 10 and exited the blind-spot zone 14 (Step 338: SemiPresent=FALSE).

Step 332 determines if an object detected in the blind-spot zone 14 is longer than a threshold length, 7.5 m for example and if the host speed of the vehicle 10 is greater than a threshold speed, 5 m/s for example, then the detected object is designated or classified as a semi-trailer and Step 336 is executed; SemiPresent=TRUE. Semi-trailers will usually meet this length criterion prior to the time that the track disappears from the middle of the semi-trailer. Once this criterion is met, the SemiPresent flag is held TRUE on future iterations until either the blind-spot alert is deactivated (Step 352), the criteria of Step 334 are met, or the system is reinitialized (Step 302).

Step 334 is designed to more readily release a semi-trailer from being tracked when the semi-trailer is about to complete a pass of the vehicle 10. That is, the semi-trailer has fully exited the blind-spot zone 14. An advantage of a more speedy release is that doing so avoids keeping the alert 18 activated for an unnecessarily long time. This is accomplished in this example by a combination of tests that must all be passed in order for the system 12 stop classifying an object corresponding to one or more tracks as being a semi-trailer. The combination of tests are: “Is Track[i] RelativeSpeed>1 m/s?”; “Is Track[i]LongitudinalPosition>−2 m?”; and “Is LargeRearTimer>1.5 s.

The first test “Is Track[i] RelativeSpeed>1 m/s?” checks to assure that the semi-trailer is actually moving relative to the vehicle faster than a speed threshold, one meter per second for example. The second test “Is Track[i]LongitudinalPosition>−2 m?” checks to assure that Track[i] is near the front bumper of the vehicle 10, e.g., only 2 m behind the front bumper. The third test “Is LargeRearTimer>1.5 s?” determines that no target has been detected in the large-rear zone 26A for at least a duration threshold, one-point-five seconds for example.

Step 350 “Does host vehicle meet blind spot requirements?” verifies that the vehicle 10 is moving at greater than some threshold speed where the operator of the vehicle 10 might contemplate a lane change. For example, if the vehicle is parked or the yaw rate is very high (e.g. the vehicle 10 is turning), then the outcome of the test is NO, so the method 300 executes Step 352 which resets all of the variables listed to their initial values, similar to as was done in Step 302. If the outcome of Step 350 is YES, a sequence of tests are performed to determine if an alert 18 should be activated; see Step 370 “BlindSpotAlert=TRUE”.

Step 354 checks to see if the variable AnyBlindSpotTrack is set to TRUE, which is done by Step 308. If YES, a BlindSpotTimer is initialized or zeroed in Step 356, and the alert 18 is provided to the operator of the vehicle 10; see Step 370 “BlindSpotAlert=TRUE”. If NO, that is an indication that the detected object has exited the blind-spot zone and no tracks are present in the blind-spot zone, so the method 300 proceeds to the combination of Steps 358, 360, 362, and 364 that determine how long the alert 18 should remain activated based on what was previous detected, a semi-trailer or some other object. That is, if the blind-spot zone 14 suddenly appears to be vacant while an alert 18 is activated (BlindSpotAlert=TRUE), the method 300 keeps the alert 18 activated for a time-interval, where that time-interval is dependent on what was detected in the blind-spot zone 14.

Step 358 determines the minimum time that the alert 18 will remain activated for a first time-interval 30 if the blind-spot zone 14 suddenly appears to be vacant while an alert 18 is activated, 0.5 seconds for example. If the value of the BlindSpotTimer is greater than or equal to 0.5 seconds, Step 360 “Is SemiPresent TRUE?” checks to see if the object was classified as a semi-trailer. If NO, e.g. because the previously detected object was not classified as a semi-trailer because, for example, it is an automobile, after 0.5 seconds the method 300 resets various timers and turns off the alert 18 by setting BlindSpotAlert=FALSE in Step 352. If YES because the previously detected object was classified to be a semi-trailer, the method 300 proceeds to Step 362.

Step 362 provides for a second time-interval 32 that is longer than or greater than the first time-interval 30 that the alert 18 remains activated after a semi-trailer exits the blind-spot zone 14 when compared to when an automobile exits the blind-spot zone 14. If NO, the activation of the alert 18 is maintained by Step 370. If YES, a combination of tests is performed in Step 364 to make sure that the semi-trailer has indeed exited the blind spot zone 14 before the alert 18 is deactivated by setting BlindSpotAlert=FALSE.

Step 364 in this non-limiting example includes various combinations of timer values compared to various time thresholds to verify that the semi-trailer has indeed exited the blind spot zone 14. These timers attempt to capture the typical behavior that occurs with sporadically appearing radar tracks in these regions when a semi-trailer is present in the blind-spot zone 14. If NO, then all the tests performed indicate that the semi-trailer has exited, so the blind-spot zone 14 is not occupied by a semi-trailer and the method 300 resets various timers and turns of the alert 18 by setting BlindSpotAlert=FALSE in Step 352. If YES, at least one of the tests in Step 364 suggests that the semi-trailer is still present in the blind-spot zone 14, so the activation of the alert 18 is maintained by Step 370. If the SmallRearTimer<=1.5 s OR the SmallSideTimer<=1.5 s, then that is an indication that the semi-trailer is still present. Also, if the SmallRearTimer<=4.5 s AND the LargeSideTimer<=3 s), then that is an indication that the semi-trailer is still present. Similarly, if the SmallSideTimer<=4.5 s AND the LargeRearTimer<=3 s, then that is an indication that the semi-trailer is still present. If the LargeRearTimer<=1 s AND the SmallSideTimer<=12 s, then that is an indication that the semi-trailer is still present. Finally, if the LargeSideTimer<=1 s AND the SmallRearTimer<=12 s, then that is an indication that the semi-trailer is still present. It is recognized that the sizes of the various zones may be varied and the values of the various timer thresholds may be varied to provide different system performance characteristics in accordance with customer desires.

Step 366 “Collect new Track data during the elapse of CycleTime” is performed to update the location of any previously tracked radar returns, search for additional radar returns previously untracked, and note when previously tracked radar returns have ‘disappeared’ from view.

Accordingly, a system 12 for detecting an object in a blind-spot zone 14 of an operator of a vehicle 10, a controller 16 for the system 10, and methods 200 and 300 of operating a radar system for detecting an object in a blind-spot zone 14 of an operator of the vehicle 10 are provided. By varying the size of areas searched by the system 12, computational burden on the controller 16 is reduced. The methods describe improved ways to prevent false detections of objects, and turn off the alert 18 when those objects leave the blind-spot zone 14.

While this invention has been described in terms of the preferred embodiments thereof, it is not intended to be so limited, but rather only to the extent set forth in the claims that follow.

We claim:

1. A system for detecting an object in a blind-spot zone of an operator of a vehicle, said system comprising:
a radar sensor that emits a radar signal toward a blind-spot zone, detects a radar track reflected by an object in the blind-spot zone, and outputs a detection signal indicative of a detected object in the blind-spot zone; and
a controller that
receives the detection signal from the radar sensor,
determines if the detection signal is indicative of a detected object in the blind-spot zone,
activates an alert to indicate to the operator that the detected object is present in the blind-spot zone,
deactivates the alert a first time-interval after the detected object exits the blind-spot zone when the detected object is not larger than the size threshold, and
deactivates the alert a second time-interval after the detected object exits the blind-spot zone when the detected object is larger than the size threshold, wherein the second time-interval is greater than the first time-interval.

2. The system in accordance with claim 1, wherein the controller determines if the detected object is within a first portion of the blind-spot zone, determines if the detected object is greater than a size threshold, and
reconfigures the system to detect objects within a second portion of the blind-spot zone different from the first portion if the detected object is within a first portion of the blind-spot zone and the detected object is greater than a size threshold.

3. A system for detecting an object in a blind-spot zone of an operator of a vehicle, said system comprising:
a radar sensor that emits a radar signal toward a blind-spot zone, detects a radar track reflected by an object in the blind-spot zone, and outputs a detection signal indicative of a detected object in the blind-spot zone; and
a controller that
receives the detection signal from the radar sensor,
determines if the detected object is within a first portion of the blind-spot zone,
determines if the detected object is greater than a size threshold, and
reconfigures the system to detect objects within a second portion of the blind-spot zone different from the first portion if the detected object is within a first portion of the blind-spot zone and the detected object is greater than a size threshold.

4. The system in accordance with claim 3, wherein the controller receives a detection signal from the radar sensor,
determines if the detection signal is indicative of a detected object in the blind-spot zone,
activates an alert to indicate to the operator that the detected object is present in the blind-spot zone,
deactivates the alert a first time-interval after the detected object exits the blind-spot zone when the detected object is not larger than the size threshold, and
deactivates the alert a second time-interval after the detected object exits the blind-spot zone when the detected object is larger than the size threshold, wherein the second time-interval is greater than the first time-interval.

5. A method of operating a radar system for detecting an object in a blind-spot zone of an operator of a vehicle, said method comprising:
providing a system configured to detect radar tracks indicative of a detected object proximate to a vehicle using radar;
detecting, by the system, a radar track within the blind-spot zone;
activating an alert to indicate to the operator that the detected object is present in the blind-spot zone;
deactivating the alert a first time-interval after the detected object exits the blind-spot zone when the detected object is not larger than the size threshold; and
deactivating the alert a second time-interval after the detected object exits the blind-spot zone when the detected object is larger than the size threshold, wherein the second time-interval is greater than the first time-interval.

6. The method in accordance with claim 5, said method further comprising:
detecting, by the system, a radar track within a first portion of the blind-spot zone;
determining that the detected object is larger than a size threshold; and
reconfiguring the system to detect radar tracks within a second portion of the blind-spot zone different from the first portion when the detected object is larger than the size threshold.

7. A method of operating a radar system for detecting an object in a blind-spot zone of an operator of a vehicle, said method comprising:
providing a system configured to detect radar tracks indicative of a detected object proximate to the vehicle using radar;
detecting, by the system, a radar track within a first portion of the blind-spot zone;
determining that the detected object is larger than a size threshold; and
reconfiguring the system to detect radar tracks within a second portion of the blind-spot zone different from the first portion when the detected object is larger than the size threshold.

8. The method in accordance with claim 7, said method further comprising:
detecting, by the system, a radar track within the blind-spot zone;
activating an alert to indicate to the operator that the detected object is present in the blind-spot zone;
deactivating the alert a first time-interval after the detected object exits the blind-spot zone when the detected object is not larger than the size threshold; and
deactivating the alert a second time-interval after the detected object exits the blind-spot zone when the detected object is larger than the size threshold, wherein the second time-interval is greater than the first time-interval.
